(19) United States
(12) Patent Application Publication
(10) Pub. No.: US 2015/0193600 A1
(43) Pub. Date: Jul. 9, 2015

(54) RIGHTS MANAGEMENT SERVER AND RIGHTS MANAGEMENT METHOD

(71) Applicant: CANON KABUSHIKI KAISHA, Tokyo (JP)

(72) Inventor: Kotaro Matsuda, Kawasaki-shi (JP)

(21) Appl. No.: 14/566,286

(22) Filed: Dec. 10, 2014

(30) Foreign Application Priority Data
Jan. 7, 2014 (JP) 2014-001241

(51) Int. Cl. G06F 21/10; H04L 29/06

(52) U.S. Cl. CPC G06F 21/10; H04L 63/08; G06F 2221/0711

(57) ABSTRACT

By delegating an access right to a resource from a user having the access right to a client, the client can also access the resource. At this time, an upper limit is set for the number of accesses per predetermined period of time and per client, and when the upper limit is exceeded, access is restricted. For a client that desires a number of accesses exceeding the upper limit, raising the upper limit by a predetermined number of times is permitted in exchange for payment of an additional fee.

### BACKGROUND OF THE INVENTION

1. Field of the Invention

The present invention relates to a rights management server and a rights management method that manage access rights to resources. More particularly, the present invention relates to a rights management server and a rights management method that manage and limit the number of resource usages on a client ID by client ID basis.

2. Description of the Related Art

Mobile terminals such as smart phones and tablet computers are spreading rapidly in recent years. Systems are available that allow applications developed by application developers to be easily published and sold to the users of such mobile terminals via application stores on the Internet. Internet service businesses are also coming into use that provide functions of applications developed for mobile terminals that are difficult to be implemented by mobile terminals alone as Internet web services and collect web service usage fees. In particular, there is a web service providing architecture called “BaaS” (Backend as a Service) that bills for the number of uses of a web service API without requiring a server-side code development and server operation.

In the case of developing and operating an application for terminals that uses a web service such as BaaS described above, it is the application developer who signs a contract to use the BaaS. If it is assumed that, for example, the BaaS provides an API that converts an electronic document file that cannot be displayed on a mobile terminal into another electronic document file format, the developer may configure the application such that the API of the BaaS can be invoked whenever format conversion is necessary within the application. On the other hand, for the end users, the format conversion appears to be one of the functions of the application, but the end users do not have to be aware of the presence of the BaaS that is operating on the backend. The application developer can earn income including the application purchasing fee and the application usage fee from the end users via application stores and the like. However, the application developer has to pay, to the BaaS, the web service usage fee corresponding to the number of uses of the distributed copies of the application.

Here, there is a problem in that the application developer wants to control the fee that needs to be paid to the BaaS to be less than or equal to the income obtained from the end users. However, it is difficult to estimate in advance the number of distributed copies of the application and the number of invocations of the web service from the application, and it is therefore difficult to accurately estimate in advance the fee billed by the BaaS. The following three cases can be given as examples thereof.

Case 1: a sudden increase in the number of distributed copies of the application causes a sudden increase in the number of API invocations.

Case 2: the API is invoked a large number of times by the terminals of some heavy users, and the number of API invocations reaches its upper limit, as a result of which a situation occurs in which other users cannot invoke the API, or in which a fee higher than expected is billed to the developer by the BaaS.

Case 3: the distributed copies of the application are no longer used, and the income from the application from the end users to the application developer is reduced. In this case, it is necessary to reduce the fee paid to the BaaS. In the case of a stepped pay-per-use billing menu system, the developer has to take time and effort so as to make a determination to change the billing option to a lower menu.

According to conventional terms of use of a BaaS provider or the like, if the upper limit of the contracted fee plan is exceeded, generally, a service operation of issuing an alert to the contractor so as to request the contractor to change the billing plan to an upper plan is performed. However, as described above, it is difficult to estimate how many times the web service is used by the distributed copies of the application. Accordingly, if the above-described cases occur, troubles and negative effects may occur, for example, the developer loses the opportunity to sell or bill for the application, and the end users cannot use the functions of the application.

Japanese Patent Laid-Open No. 2004-310652 discloses a related technique, for use in a web server, that manages and limits the number of simultaneous accesses to each object. This related technique, however, does not control API invocations by distributed copies of an application or billing resulting from the invocations.

### SUMMARY OF THE INVENTION

The present invention provides a system that can control web service API invocations by an application developed by an application developer as well as billing resulting from the invocations.

A system according to the present invention has the following configuration.

A rights management server including: an issuing unit configured to, in response to an authorization request requesting for delegation of access right to a resource of a user from a registered client, verify the authorization request and issue an access token to the client when the verification is successful; and a verification unit configured to, when a resource request is received together with the access token, verify the access token and permit access to the resource when the verification is successful, wherein the verification unit is configured to verify validity of the access token, also verify whether or not the number of accesses to the resource has exceeded a maximum number of accesses set for a client that issued the resource request, and determine that the access token has been successfully verified when the access token is valid and the number of accesses to the resource does not exceed the maximum number of accesses.

According to the present invention, it is possible to limit and control the number of accesses to a resource such as the number of web service API invocations by an application on a client-by-client basis by controlling the access rights of clients. It is also possible to perform flexible setting of the upper limit of the number of accesses to the resource.

Further features of the present invention will become apparent from the following description of exemplary embodiments with reference to the attached drawings.

### BRIEF DESCRIPTION OF THE DRAWINGS

FIG. 1 is a diagram showing a system configuration and a network configuration for carrying out the present invention.

FIG. 2 is a diagram showing a hardware configuration of information processing functions.

FIG. 3 is a diagram illustrating a software configuration of a system according to the present invention.

FIG. 4A is a diagram showing a tenant management table.

FIG. 4B is a diagram showing a user management table.

FIG. 5A is a diagram showing an API billing menu management table.

FIG. 5B is a diagram showing a tenant attribute information management table.

FIG. 6A is a diagram showing a client certificate management table.

FIG. 6B is a diagram showing a client management table.

FIG. 6C is a diagram showing an access token management table.

FIG. 6D is a diagram showing an API invocation count management table.

FIG. 7 is a diagram illustrating a flow for enrolling to use a web service.

FIG. 8A is a diagram showing an enrollment screen.

FIG. 8B is a diagram showing an API usage settings screen.

FIG. 9 is a diagram showing a flow of processing for registering a client and a flow for issuing an access token.

FIG. 10 is a diagram illustrating a flow of processing for making a request for an API as a resource.

FIG. 11 is a diagram illustrating a flow of processing for performing addition to a maximum number of API invocations.

FIG. 12A is a diagram showing a UI for selecting to perform addition to maximum number of API invocations.

FIG. 12B is a diagram showing a cost recovery selection UI.

FIG. 13 is a diagram illustrating a flow of processing for deleting a client ID.

FIG. 14 is a flowchart for automatically deleting a client ID.

### DESCRIPTION OF THE EMBODIMENTS

Hereinafter, a preferred embodiment for carrying out the present invention will be described with reference to the drawings. In order to provide a secure API authorization unit from a web service to an application, the present embodiment is configured to use OAuth 2.0, which is an internet standard. In particular, the present embodiment provides an API authorization unit that uses the Client Credentials Grant type of OAuth 2.0 to an application for mobile terminals in order to identify individual terminals and enable access control on a terminal-by-terminal basis.

System Configuration

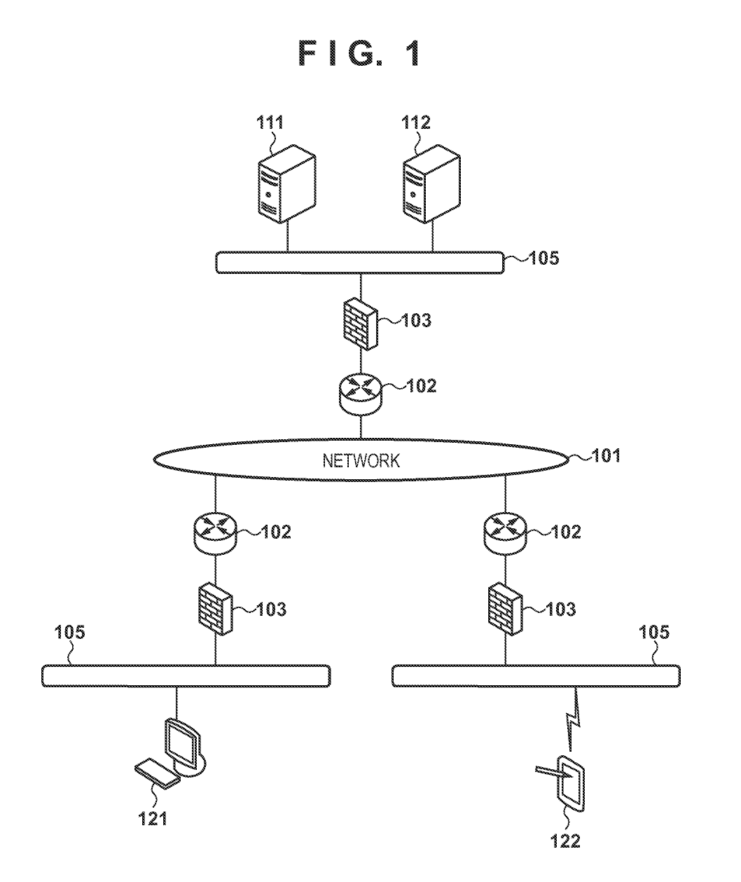

FIG. 1 shows an example of a system configuration and a network configuration of a resource providing system for carrying out the present invention. A network 101 is the Internet or Intranet. A network device 102 is a device that connects networks such as a router or a switch. A firewall 103 performs control on permission to perform communication between networks. A LAN (local area network) 105 is an end-use network that connects computers and the like. The LAN 105 is not limited to a wired communication network, and may be a wireless communication network such as a wireless LAN or a mobile phone communication network. An authorization server 111 is a rights management server that manages the access rights to a resource server 112 or the like of users or clients, which will be described later. The resource server 112 is a server that provides, for example, a service such as application processing as a resource. Client computers 121 and 122 are, for example, personal computers, tablet computers or smart phones that execute an application program or the like and access the resource server 112.

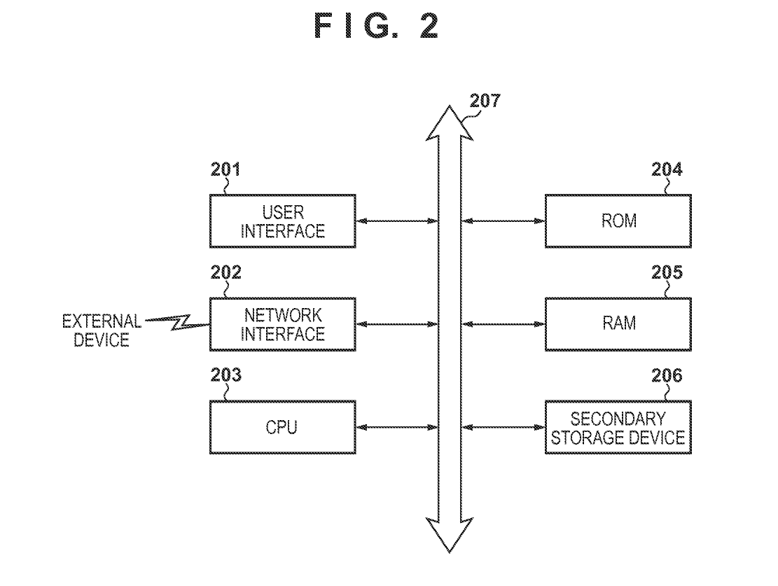

FIG. 2 is a diagram showing a configuration of an information processing function module of the authorization server 111, the resource server 112, and the client computers 121 and 122. A user interface 201 performs input and output of information with the use of a display, a keyboard, a mouse, a touch panel and the like. A computer that does not include such hardware can be connected or operated from another computer by a remote desktop, remote shell or the like. A network interface 202 connects to a network such as a LAN and performs communication with another computer or network device. A ROM 204 is a ROM in which installed programs and data are recorded. A RAM 205 serves as a temporary memory area for data, programs and the like. A secondary storage device 206 is a storage device as typified by a HDD, and stores therein program files and data files. A CPU 203 executes programs read from the ROM 204, the RAM 205, the secondary storage device 206 and the like. These constituent elements are connected via an input/output interface 207.

Software Configuration

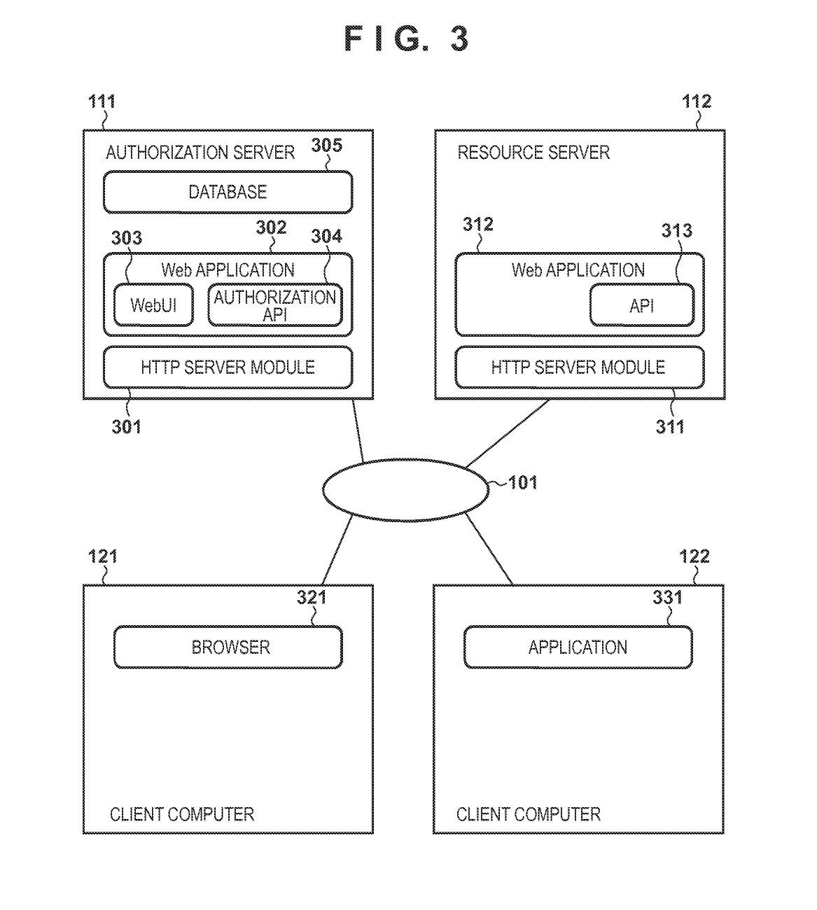

FIG. 3 shows a software configuration of the system of the present invention. The authorization server 111 includes an HTTP server module 301, a web application 302, and a database 305. The HTTP server module 301 manages and controls communication of web access requests and responses with respect to clients, and if necessary transfers a request to the web application 302. The web application 302 includes a web UI 303 that provides a web document such as an HTML or an operation screen to a browser, and an authorization API 304 that accepts authorization processing from a web service API as typified by REST. The database 305 stores therein data used by the web application 302. In response to a request from the web application 302, the database 305 performs addition, reading, updating or deletion of a record with respect to various types of tables.

The resource server 112 includes an HTTP server module 311 and a web application 312. The HTTP server module 311 manages and controls communication of web access requests and responses with respect to clients, and if necessary transfers a request to the web application 312. The web application 312 includes an API 313 that accepts various types of processing with the use of a web service API as typified by REST. The API 313 executes processing required by a function provided by the resource server, generates a response to an API invocation request from a client, and returns the response to the client via the HTTP server module 311. Because the resource server can provide various types of functions, if there is a function that cannot be executed by the web application 312 alone, it is possible to obtain a response by requesting another application or another server, which are not shown, for execution of the function.

A browser 321 is installed on the client computer 121 so as to be capable of being executed. The browser 321 receives a web document such as HTML or an operation screen provided by the web UI 303, displays the web document or the operation screen, and transmits a result of operation by the user or the like to the web UI 303.

An application 331 is installed on the client computer 122 so as to be capable of being executed. The application 331 can use various types of functions provided by the resource server 112 by accessing the API 313.

The following is a description of, in the configuration shown in FIG. 3, which role in the OAuth 2.0 each module has. The authorization server 111 has a role of “Authorization Server” in the OAuth 2.0. The resource server 112 has a role of “Resource Server” in the OAuth 2.0. The application 331 has a role of “Client” and a role of “Resource Owner” in the OAuth 2.0. In the following description, each module executes an API authorization flow as the role in the OAuth. Also, the term “client” as used in this specification or in the diagrams refers to an individual application 331 that functions as a role of “Client” in the OAuth 2.0 and issues a request for a web service API such as the authorization API 304 or the API 313.

Tables in Authorization Server

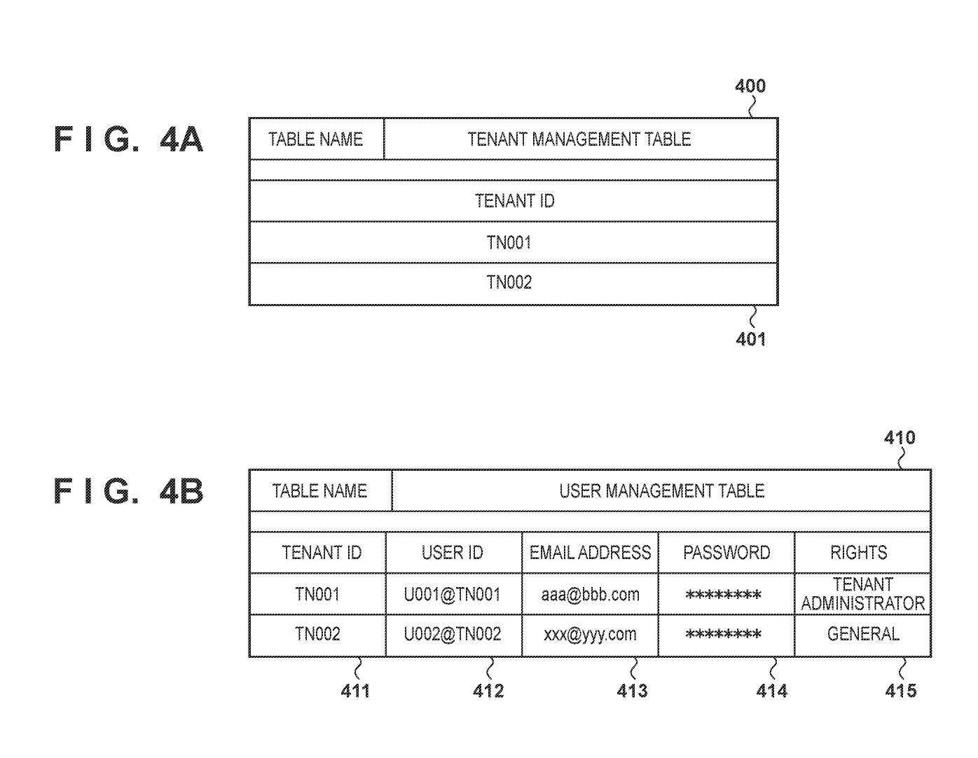

FIGS. 4A, 4B, 5A and 5B and FIGS. 6A to 6D show various types of tables stored in the database 305 of the authorization server 111. A tenant management table 400 is a table for managing tenant IDs. Tenant ID 401 is a column in which tenant IDs are stored. The tenant ID 401 is a unit for securely separating a resource when a web service provided by the authorization server or the resource server is used by various organizations, individuals and the like. Such a system is generally called a “multi-tenant system”.

A user management table 410 is a table for managing users. Tenant ID 411 is a column in which tenant IDs to which users belong are stored. User ID 412 is a column in which user IDs that belong to the corresponding tenant IDs are stored. Email Address 413 is a column in which email addresses of the users are stored. Password 414 is a column in which passwords of the users are stored. Rights 415 is a column in which the rights given to the tenants to which the users belong are stored. Here, it is assumed that the rights 415 include a tenant administrator right having the right to access all of the data within the tenant and a general user right having only limited rights.

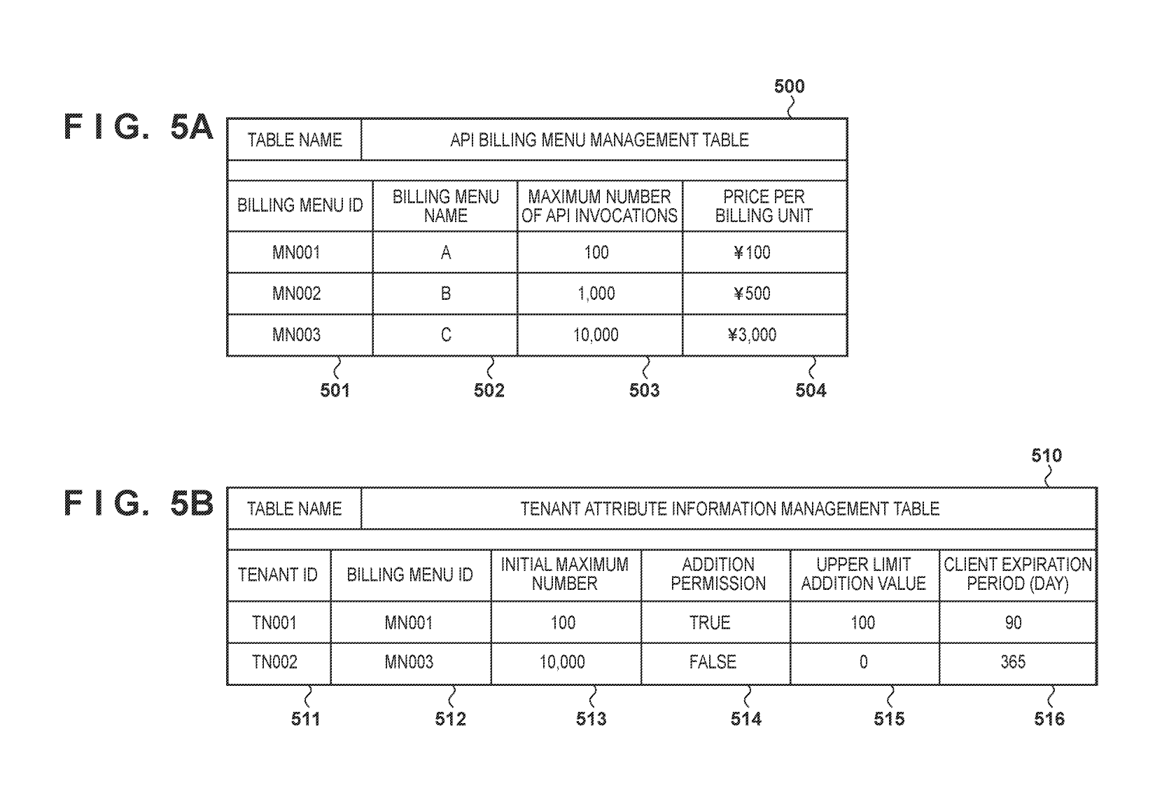

An API billing menu management table 500 shown in FIG. 5A is a table for managing billing menus prepared in the authorization server 111. Billing Menu ID 501 is a column in which billing menu IDs are stored. Billing Menu Name 502 is a column in which billing menu names are stored. Maximum Number of API Invocations 503 is a column in which a maximum number of API invocations per client ID is stored. In the present embodiment, the maximum number of API invocations is an upper limit value within a pre-set unit period. An API invocation is an access to the resource provided by the resource server 112, and thus can be rephrased as the upper limit of the number of accesses or the maximum number of accesses. Unit Price 504 is a column in which the price per billing unit is stored. In the present embodiment, an example is shown in which a right to use the maximum number of API invocations per client ID set in Maximum Number of API Invocations 503 once is defined as one unit of billing, and the number of billing units used is billed. However, there may be various types of billing forms, and thus merely one example is given here.

A tenant attribute management table 510 shown in FIG. 5B is a table for managing attributes for each tenant. Tenant ID 511 is a column in which tenant IDs are stored. Billing Menu ID 512 is a column in which billing menu IDs selected by the corresponding tenants are stored. Initial Maximum Number 513 is a column in which the initial value of the maximum number of API invocations per client ID is stored. Addition Permission 514 is a column in which addition permission information, which is a set value indicating whether or not to permit addition to the maximum number of API invocations, is stored. Upper Limit Addition Value 515 is a column in which the number to be added to the maximum number of API invocations per client ID is stored. Client Expiration Period 516 is a column in which periods (predetermined lengths of time) that are referred to when a function of automatically deleting a client that does not access the resource for a predetermined length of time is executed are stored.

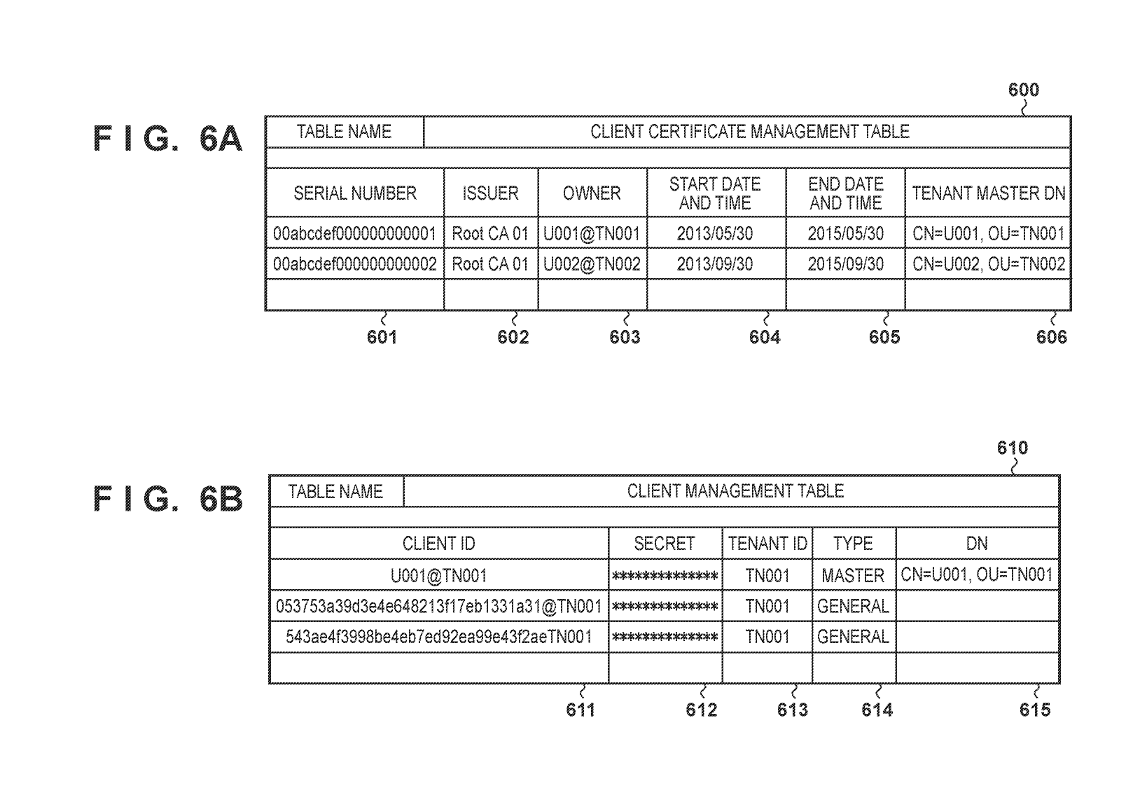

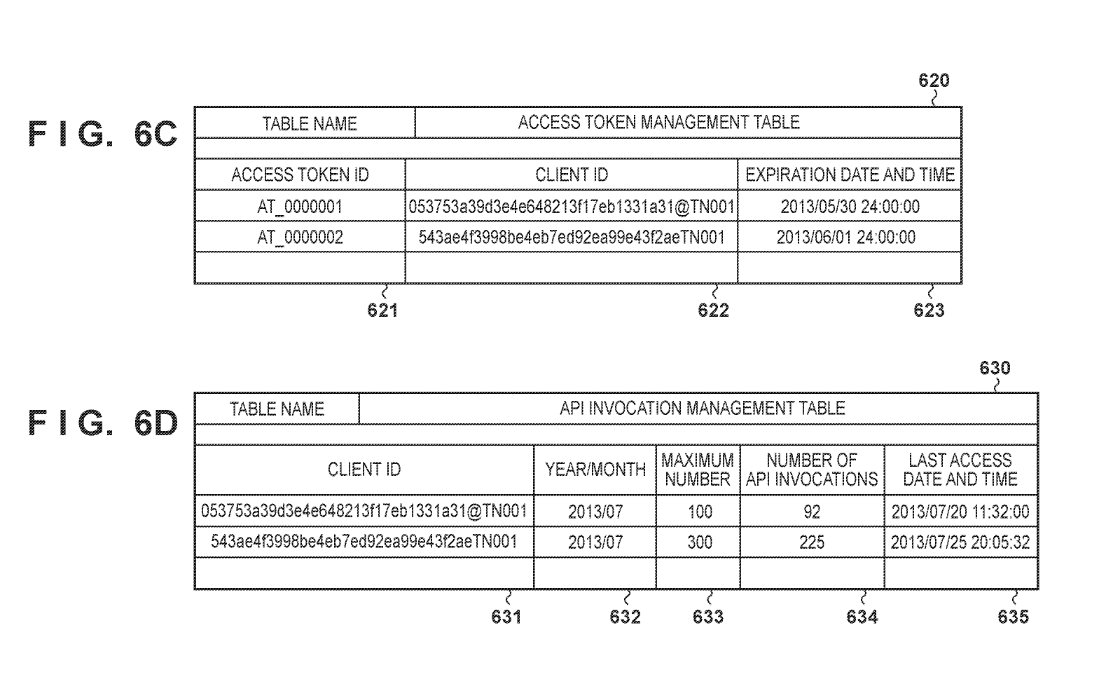

A client certificate management table 600 shown in FIG. 6A is a table for managing client certificates. The client certificates are created according to the API usage settings by the users. The client certificates are distributed, for example, from a user to the clients and are used to authenticate the clients. Serial Number 601 is a column in which the serial numbers of the client certificates are stored. Issuer 602 is a column in which the issuers of the certificates are stored. Owner 603 is a column in which the owners of the certificates are stored. Start Date and Time 604 is a column in which the start date and time of the valid period of the certificates is stored. End Date and Time 605 is a column in which the end date and time of the valid period of the certificates is stored. Tenant Master DN 606 is a column in which tenant master distinguished names (DN) are stored.

A client management table 610 shown in FIG. 6B is a table in which various types of information for managing clients are stored. Client ID 611 is a column in which client IDs are stored. Secret 612 is a column in which the secrets of the clients are stored. Tenant ID 613 is a column in which tenant IDs to which the clients belong are stored. Type 614 is a column in which the types of clients are stored. As the client type 614, there are a master right having the right to manage tenants and a general client right having only limited rights. DN 615 is a column in which tenant master DNs of the clients are stored. With the use of the client management table 610, the clients in the OAuth 2.0 are individually identified and managed.

An access token management table 620 shown in FIG. 6C is a table for managing access tokens. Access Token ID 621 is a column in which the ID specific to each access token is stored. Client ID 622 is a column in which client IDs for which access tokens are issued are stored. Expiration Date and Time 623 is a column in which the expiration date and time of the access tokens is stored.

An API invocation count management table 630 shown in FIG. 6D is a table for managing the number of invocations of API on a client-by-client basis. Client ID 631 is a column in which client IDs are stored. Year/Month 632 is a column which the month and year for which the number of API invocations is counted is stored. In the present embodiment, a calendar month is used as the unit period, and the number of API invocations is counted monthly. However, the number of API invocations may be counted on another periodic basis or unit such as yearly or weekly. Maximum Number 633 is a column in which set values of the maximum number of API invocations are stored. Number of Invocations 634 is a column in which the number of times the API was actually invoked by each client is stored. Last Access Date and Time 635 is a column in which the date and time of last access to the API from each client is stored.

User Enrollment Procedure

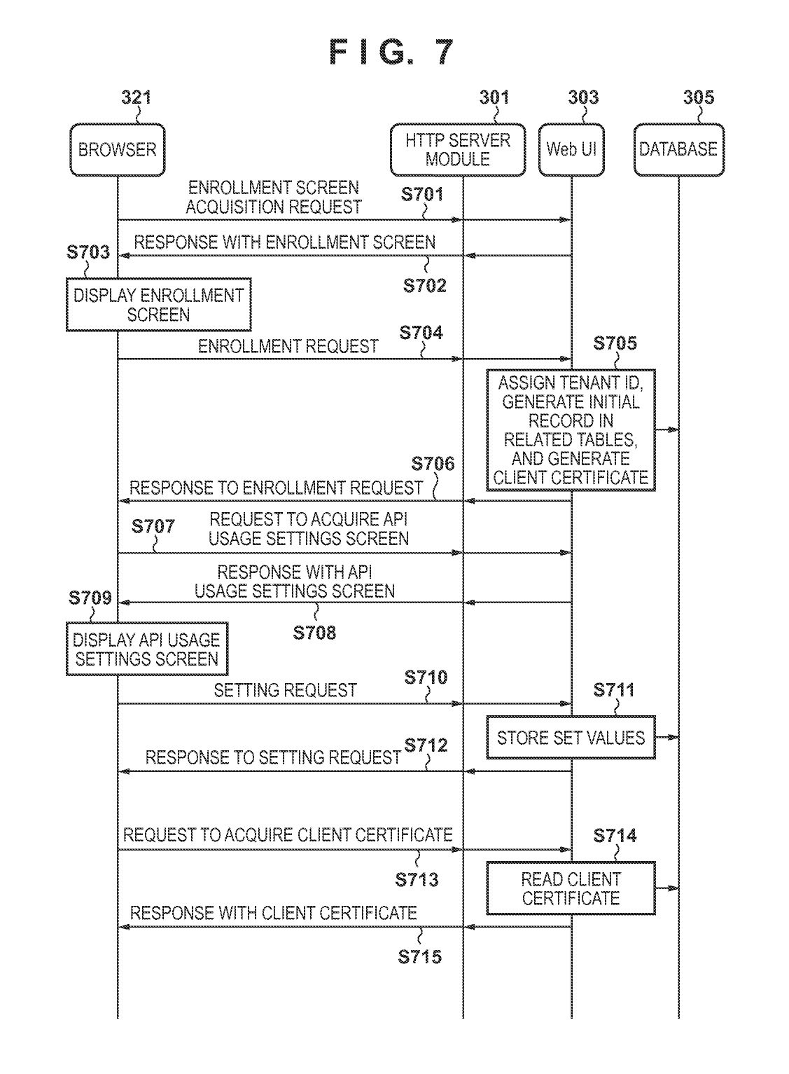

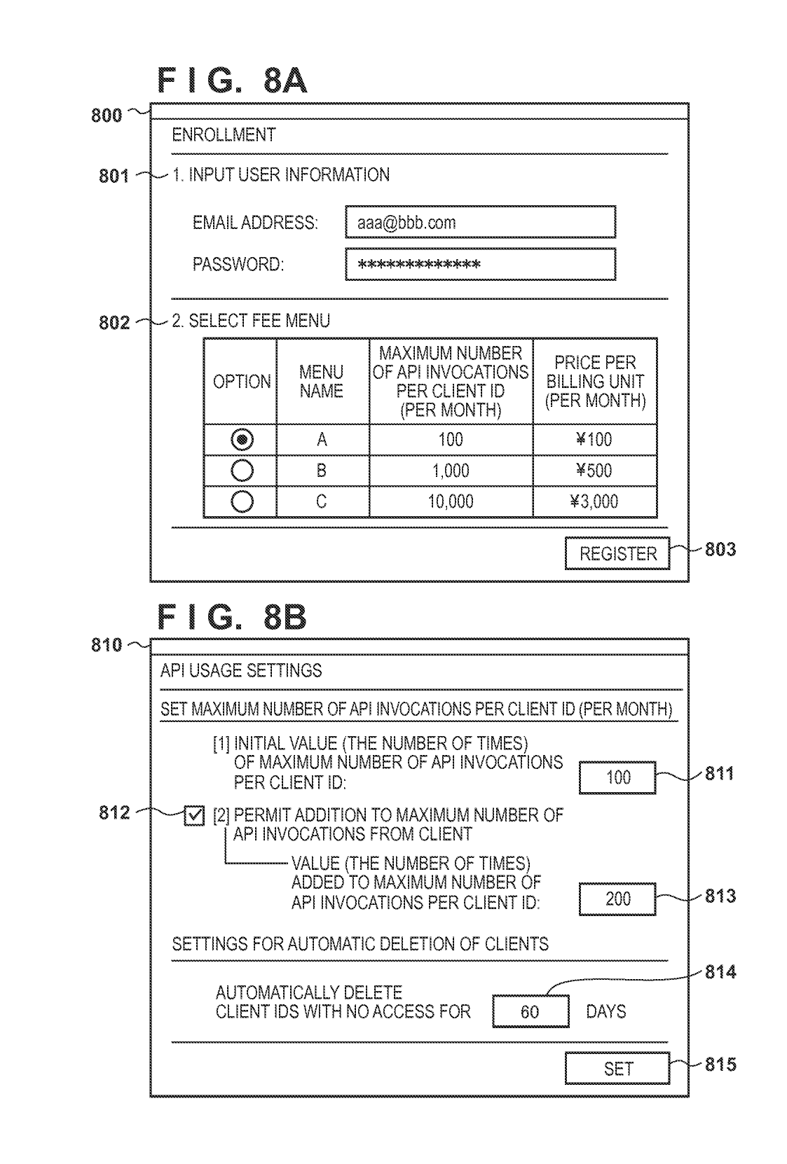

A flow of processing for enrolling to use a web service provided by the authorization server 111 or the resource server 112 will be described with reference to FIGS. 7, 8A and 8B. Here, it is assumed that the enrolled user is the developer of the application 331.

When the user designates a predetermined URI and transmits an enrollment screen acquisition request to the HTTP server module 301 by using the browser 321, the browser 321 acquires and displays an enrollment screen 800 provided by the web UI 303 that has received the request via the HTTP server module 301 (S701, S702 and S703). The enrollment screen 800 is an input screen for inputting user information and a fee menu. The exchange of requests and responses between the browser 321 and the web UI 303 is performed via the HTTP server module 301, but the following will be described without mentioning this. User Information 801 is a user information input field in which the email address and password of the user are input. Fee Menu 802 is a field in which a fee menu is selected. Each menu is associated with a billing menu ID, and thus the billing menu ID is identified according to the selected menu. The web UI 303 reads the API billing menu management table 500 in response to the enrollment screen acquisition request, and provides options in Fee Menu 802. A registration button 803 is a button used to transmit an enrollment request. When the user inputs information for identifying the user in User Information 801, selects a fee menu in 802, and presses the registration button 803, the browser 321 transmits, to the web UI 303, identification information of the user such as, for example, the email address and password and an enrollment request including the selected billing menu ID (S704). In response to the enrollment request, the web UI 303 first adds a new tenant ID to the tenant management table 400. The web UI 303 adds a record of the user to the user management table 410 in accordance with the input user information, and adds the right of tenant administrator to Rights 415. The user thereby can change the set values for the created tenant. The web UI 303 additionally stores the created tenant ID in Tenant ID 511 of the tenant attribute management table 510, and the billing menu ID selected in Fee Menu 802 in Billing Menu ID 512. The web UI 303 creates a client whose type 614 is “master” (referred to as a “master client”) in the client management table 610. Also, a client certificate having the same tenant master DN 606 as DN 615 of the created master client is created, and other certificate information is stored in the fields 601, 602, 603, 604 and 605 of the client certificate management table 600 (S705). Upon completion of such registration processing including creating the tenant ID, a response indicating the completion of registration is sent to the browser 321 (S706).

Next, the browser 321 acquires an API usage settings screen 810 from the web UI 303 and displays the API usage settings screen 810 (S707, S708 and S709). Initial Maximum Number 811 is a field (input field) in which the initial value of the maximum number of API invocations (the upper limit of the number of accesses) per client ID is input. Addition permission 812 is a check box in which whether or not to permit addition to the maximum number of API invocations from a client is selected. Upper Limit Addition Value 813 is a field in which the number to be added to the maximum number of API invocations per client ID is input. Client Expiration Period 814 is a field in which a predetermined length of time (deadline for automatic deletion) is input, the predetermined length of time being a length of time that is set, if a client does not use the API for that length of time, to delete the client ID.

A setting button 815 is a button for transmitting a request for API usage settings. Upon the user inputting/selecting each set value on the API usage settings screen 810 and pressing the setting button 815, the browser 321 transmits a setting request to the web UI 303 (S710). Upon receiving the setting request, the web UI 303 respectively stores the values input on the API usage settings screen 810 in Initial Maximum Number 513, Addition Permission 514, Upper Limit Addition Value 515 and Client Expiration Period 516 of the tenant attribute management table 510 (S711). The web UI 303 sends a response indicating the completion of settings to the browser 321 (S712). Next, the browser 321 transmits a request to acquire a client certificate to the web UI 303 (S713). The web UI 303 reads the created client certificate from the client certificate management table 600, and sends a response to the browser 321 (S714 and S715).

Client Registration Processing

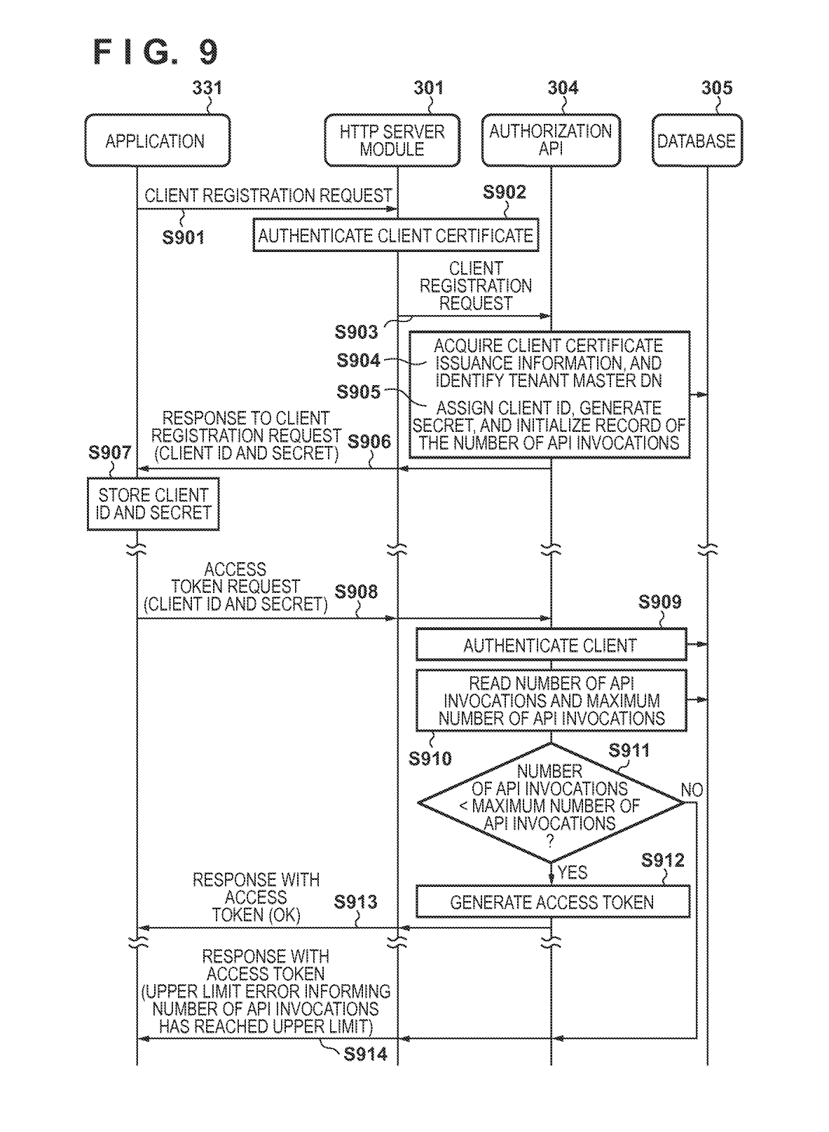

Next, a flow of client registration processing and access token issuance processing will be described with reference to FIG. 9. The client certificate given to the user according to the API usage settings has been incorporated in the application 331 by the developer of the application 331 which is a client, and the application 331 have been installed on the client computer 122.

The application 331 transmits a client registration request to the HTTP server module 301 (S901). In response to the client registration request, the HTTP server module 301 requests the application 331 for a client certificate. The application 331 transmits the client certificate to the HTTP server module 301. The HTTP server module 301 transfers the client registration request to the authorization API 304 if the received client certificate is valid (S902 and S903). The client certificate is authenticated by, for example, checking the received client certificate against the client certificate management table 600. If the received client certificate has been registered, it is determined that the received client certificate is valid, or in other words, authentication is successful. In the present embodiment, the client certificate is used to authenticate the application 331 as a legitimate client of the authorization server 111, but it is also possible to use other authentication methods such as Basic authentication and Digest authentication.

The authorization API 304 searches the client certificate management table 600 for the serial number 601 obtained from the received client certificate, and identifies the tenant master DN 606. Furthermore, the authorization API 304 searches the client management table 610, and acquires a record (i.e., the master record registered in S705) that has the same DN 615 as the identified tenant master DN 606 and whose client type 614 is “master” (S904). The authorization API 304 reads the tenant ID 613 of the acquired master record. The authorization API 304 adds the record to the client management table 610, assigns a unique ID as typified by UUID, stores the ID in Client ID 611, and stores the read tenant ID in Tenant ID 613. The authorization API 304 also stores an automatically generated secret having a sufficient character string length in Secret 612, and stores “general” in Type 614. The authorization API 304 adds the record to the API invocation count management table, and stores the assigned client ID in Client ID 631. Also, the current month and year is stored in Year/Month 632, the initial value 513 of the maximum number of API invocations per client of the tenant set in the tenant attribute management table 510 is stored in Maximum Number 633, and an initial value of 0 is stored in Number of Invocations 634 (S905). The authorization API 304 returns the generated client ID and secret to the application 331 as a response to the client registration request (S906). The application 331 stores the received client ID and secret in a storage area in such a manner that they can be read later (S907). This is a flow of processing for registering the application 331 in the authorization server 111 as a client, and only a legitimate client having a client certificate issued by the authorization server 111 can be registered in the authorization server 111.

When accessing the resource server 112, the application 331 acquires an access token from the authorization server 111, and thereby the access right is delegated from the user. Accordingly, the application 331 transmits an access token request (also referred to as an “authorization request”) to the authorization API 304 by using the acquired client ID and secret described above (S908). The authorization API 304 verifies the presence of a client ID and secret that match the received client ID and secret in the client management table 610, and if the presence is verified, authenticates the client that transmitted the request (S909). The authorization API 304 searches the API invocation count management table 630 for the client ID with which the request was transmitted, and acquires the values set in Number of API Invocations 634 for the current month and Maximum Number of API invocations 633 (S910). The authorization API 304 determines whether the value set in Number of API Invocations 634 for the current month is less than the value set in Maximum Number of API invocations 633 (S911). If yes is determined in step S911, the authorization API 304 adds a record to the access token management table 620, and generates an access token (S912). The authorization API 304 sends, to the application 331, a response indicating the access token ID 621 and the expiration date and time 623 of the generated access token (S913). If no is determined in step S911, the authorization API 304 sends, to the application 331, a response indicating an upper limit error informing that the number of API invocations has reached the upper limit (S914). The issued access token indicates that the access right to access the resource (in this example, API invocation or the provision of a service via the API) has been delegated from the user of the resource server to the client that uses the access token.

At the time of making a request for an access token for the first time after registration of the client ID, it is substantially unnecessary to determine whether the number of API invocations has reached the upper limit, which was performed in the above steps S910 and 911, and thus an access token may be issued to the application 331 without making such a determination. However, the access token has the expiration date and time 623, and thus after the expiration date and time has passed, the application 331 needs to again execute the processing from step S908 and again make a request for another access token. When making a request for an access token for the second or subsequent time, the determination of whether the number of API invocations has reached the upper limit performed in the steps S910 and 911 described above is performed. If it is determined that the number of API invocations has already reached the upper limit, an access token is not issued. The API authorization flow of the OAuth 2.0 is to invoke the authorized API by using the issued access token, and thus if the number of API invocations has already reached the upper limit, the invocation of the API 313 of the resource server 112 from the application 331 is inhibited. It is thereby possible to obtain effects such as the reduction of communication traffic to the resource server 112 and the reduction of CPU processing.

Resource Request Processing

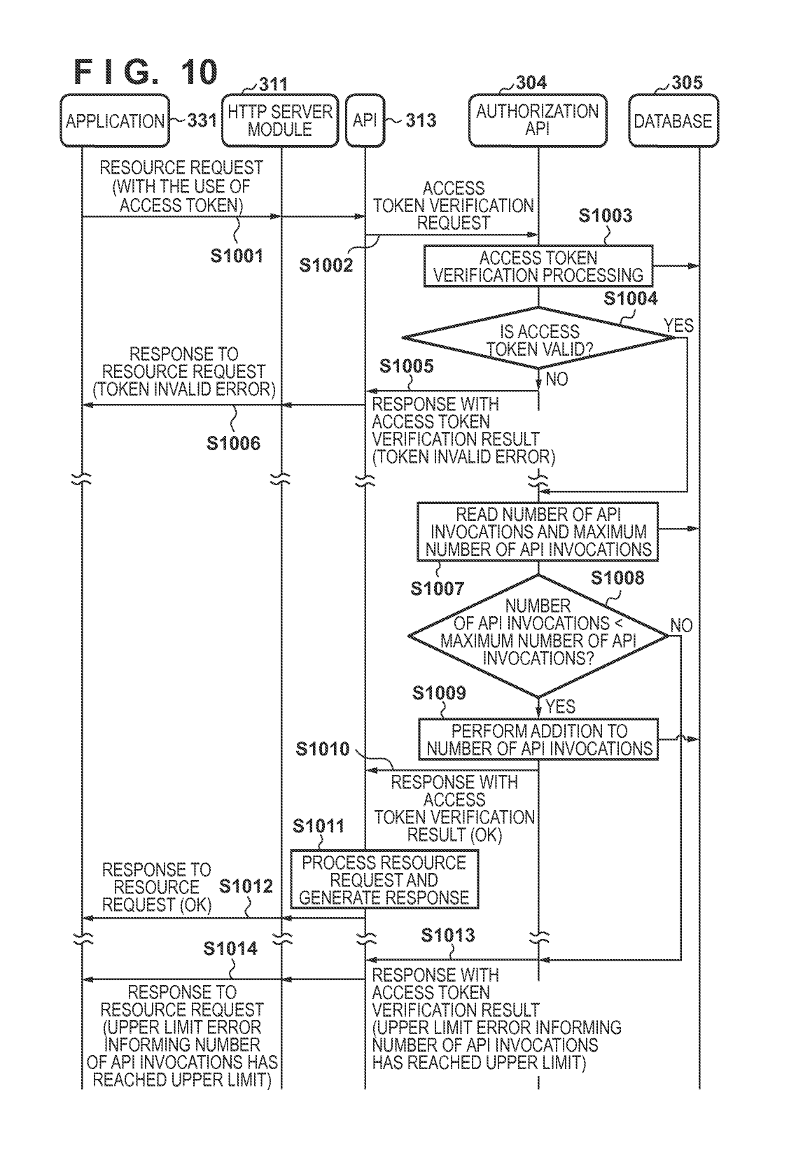

Next, a flow of processing for using the API 313 of the resource server 112 with the use of the acquired access token will be described with reference to FIG. 10. The application 331 transmits a resource request having the acquired access token attached thereto to the API 313 (S1001). The resource request is a request for using the API for the resource database 112 to provide a resource (or service) to the application. In FIG. 10, the requested API corresponds to the API 313. The API 313 transmits the received access token verification request to the authorization API 304 (S1002). The authorization API 304 searches the access token management table 620 for the access token ID of the received access token, and verifies that the current date and time is prior to the expiration date and time 623 if the corresponding access token ID is found. If the expiration date and time has not yet passed, it is determined whether the client ID 622 of the client to which the access token was issued is found in the client management table 610 so as to confirm whether the client ID is valid (S1003). If it is determined, as a result of the verification processing in step S1003, that the client ID is valid, the authorization API 304 determines that the received access token is valid (S1004). If the access token is not registered in the access token management table, if the expiration date and time has passed, or if the client ID is invalid, it is determined, as a result of the verification processing in S1003, that the access token is invalid (or not legitimate). In this case, or in other words, if no is determined in step S1004, the authorization API 304 sends a response indicating a token invalid error to the API 313 as a result obtained from the access token verification (S1005). The API 313 returns the token invalid error to the application 331 as a response to the request for API resource (S1006).

If, on the other hand, the validity of the access token is verified as a result of verification of the access token, access to the resource is permitted without issuing a request to input authentication information. Accordingly, if yes is determined in step S1004, the authorization API 304 searches the API invocation count management table 630 for the client ID of the client to which the access token was issued, and acquires the values set in Number of API Invocations 634 for the current month and Maximum Number of API invocations 633 (S1007). The authorization API 304 determines whether the value set in Number of API Invocations 634 for the current month is less than the value set in Maximum Number of API invocations 633 (S1008). If yes is determined in step S1008, the authorization API 304 adds 1 to the value in Number of API Invocations 634 for the current month of the API invocation count management table 630 (S1009). The authorization API 304 sends, to the API 313, a response indicating that the access token verification has successfully been performed (OK) (S1010). The API 313 executes processing of the resource request received in step S1001, and generates a response (S1011). The API 313 returns, as a response to the resource request, the resource response generated in step S1011 and the API invocation success (OK) to the application 331 (S1012). If no is determined in step S1008, the authorization API 304 returns, as a response to the access token verification, an upper limit error indicating that the number of API invocations has exceeded the upper limit to the API 313 (S1013). The API 313 returns, as a response to the resource request, the upper limit error to the application 331 (S1014).

Upper Limit Raising Processing

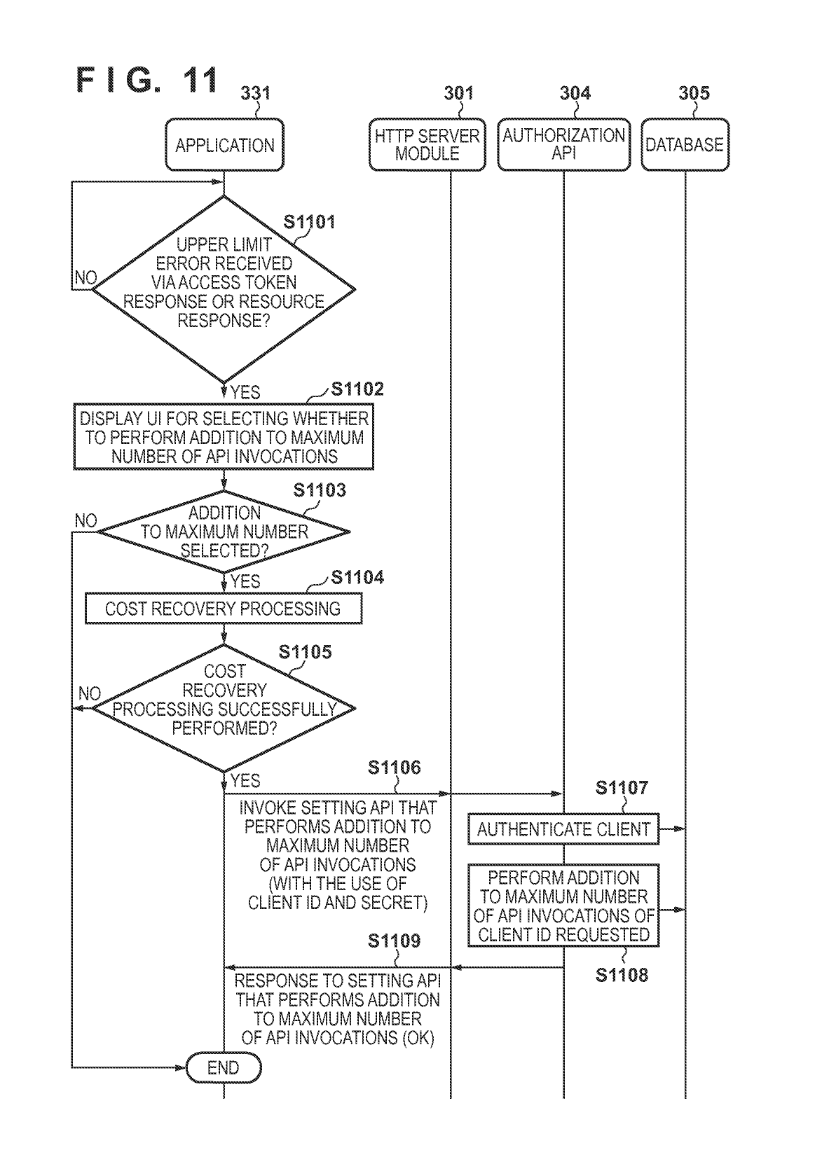

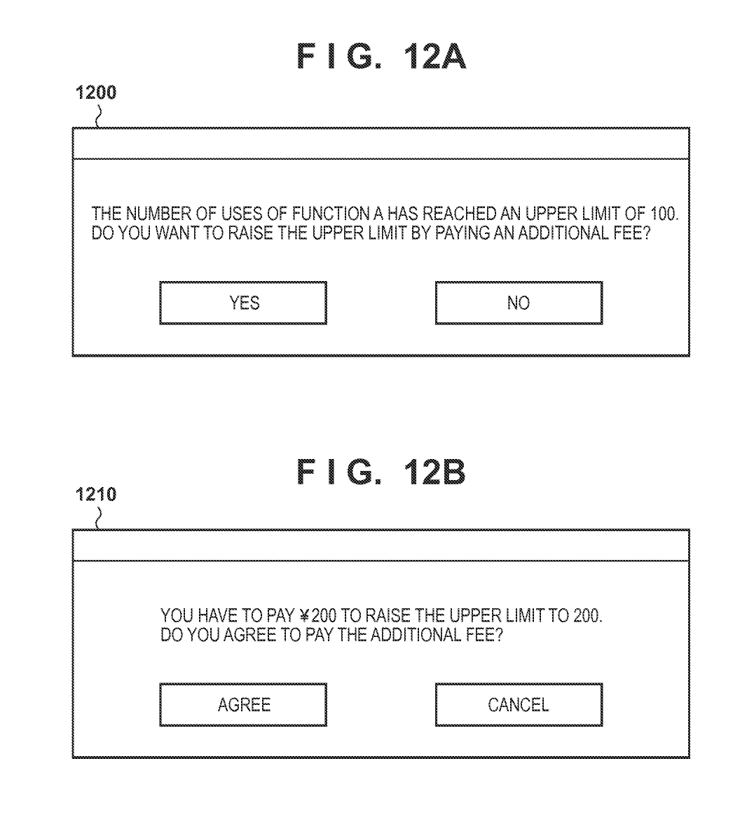

A flow of processing for raising the upper limit by performing addition to the maximum number of API invocations if the number of API invocations reaches the upper limit will be described next with reference to FIGS. 11, 12A and 12B. In step S914 or S1014 described above, the application 331 receives a notification indicating that the number of API invocations from the client ID of the application 331 has reached the upper limit (S1101). Upon receiving the notification indicating that the number of API invocations has reached the upper limit, a UI 1200 for selecting whether or not to perform addition to the maximum number of API invocations is displayed (S1102). The application 331 determines whether or not the user has made a selection of performing addition to the maximum number on the UI 1200 (S1103). If no is determined in step S1103, the processing ends. If yes is determined in step S1103, the application 331 displays a UI 1210 for performing cost recovery processing, and prompts the user to select an agreement for cost recovery for performing addition to the maximum number (S1104). At this time, the number of accesses and the fee that are displayed on the UI 1210 may be predetermined values, or may be values registered in the server. In this case, the value that can be added to the maximum number is registered in Upper Limit Addition Value 515 of the tenant attribute management table 510, and the unit price 504 according to the billing menu ID 512 is registered in the API billing menu management table. The addition permission 514 indicating whether or not to permit addition to the maximum number is also registered in the tenant attribute management table 510. Accordingly, when an upper limit error is transmitted from the authorization API 304, the addition permission 514, the upper limit addition value 515 and the unit price 504 may be transmitted to the application 331 together with the error. In this case, immediately after S1101, it is determined whether the addition has been permitted. If it is determined that the addition has not been permitted, the procedure shown in FIG. 11 ends. If it is determined that the addition has been permitted, the upper limit addition value 515 and the unit price 504 are referred to, and the number of accesses to be added and the fee are displayed on the UI 1210.

The application 331 determines whether the user has agreed to perform cost recovery, and whether the cost recovery processing from the application user to the application developer or provider has been successfully performed (S1105). If the application user presses the “Agree” button on the UI 1210, it is determined in step S1105 that the cost recovery processing has been successfully performed. If no is determined in step S1105, the processing ends. If yes is determined in step S1105, the application 331 designates the client ID and secret with respect to the API 304, and invokes a setting API (not shown) that performs addition to the maximum number of API invocations (S1106). As in step S909 described above, the authorization API 304 authenticates the client that transmitted the request (S1107). The authorization API 304 searches the client management table 610 for a record whose client ID 611 matches the client ID with which the request was transmitted, and identifies the tenant ID to which the client ID belongs. The authorization API 304 reads the record having the tenant ID of the tenant attribute management table 510, and acquires the addition value 515 that is added to the maximum number of API invocations per client ID. The authorization API 304 adds the addition value 515 acquired above to the value set in Maximum Number 633, which is the maximum number of API invocations, for the record having the client ID with which the request was transmitted in 631, and the current month and year in Year/Month 632 of the API invocation count management table 630 (S1108). A new maximum number is set as the value set in Maximum Number of API Invocations 633. The authorization API 304 returns a success (OK) to the application 331 as a response to the setting API that performs addition to the maximum number of API invocations. A configuration is also possible in which, at the beginning of S1108, first, the addition permission 514 of the tenant to which the client belongs registered in the tenant attribute management table 510 is referred to, and if the addition permission 514 indicates addition is not permitted, a response indicating an addition error is sent to the application.

Through the above procedure, when the number of uses of the API, or in other words, the number of accesses to the resource reaches a pre-set maximum number, the maximum number can be raised. In the procedure described above, the addition permission information is referred to, but raising the maximum number may be unconditionally permitted. In this case, it is unnecessary to provide the input field 812 for inputting the addition permission information shown in FIG. 8B.

Client ID Deletion Processing

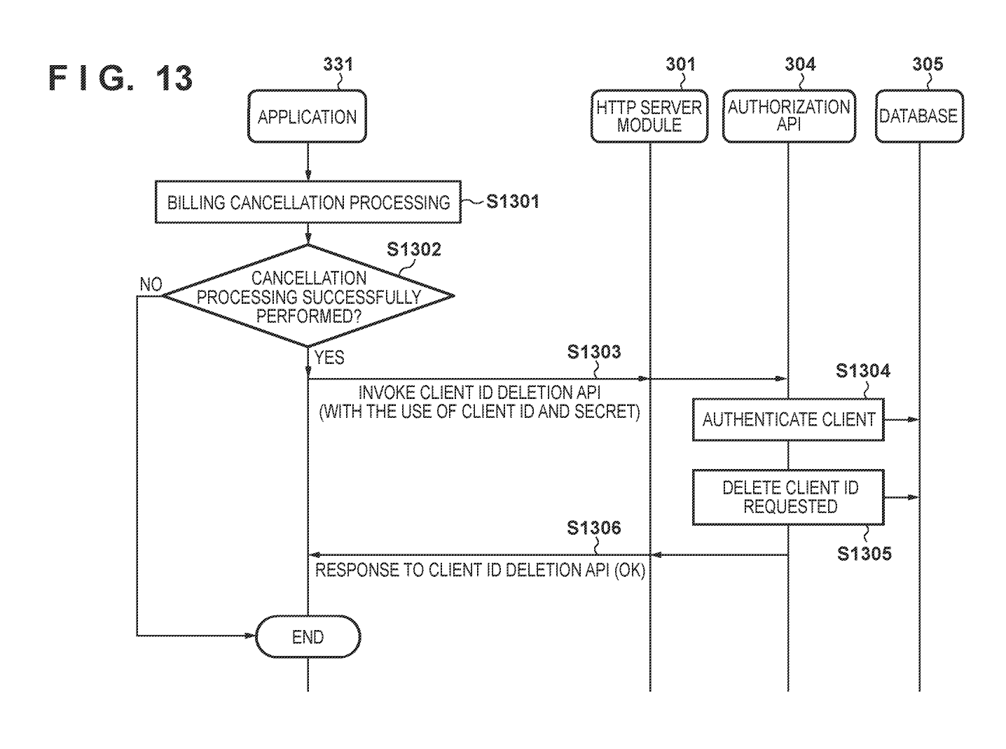

A flow of processing for deleting an unnecessary client ID will be described next with reference to FIG. 13. This processing can be used, when a function provided in the application 331 implemented by the user of the application 331 invoking the API 313 is no longer necessary, to invalidate the function, or can be used, when the user of the application 331 cancels billing from the application developer or provider, to reduce the web service API usage fee of the client. This processing is useful in the case in which, for example, when a user cancels billing from the application developer or provider, continued use of some functions of the application is enabled in the form of a free application, but continued use of some charged functions is disabled.

In the application 331, the cancellation processing for cancelling billing to the application user from the application developer or provider is executed (S1301). The application 331 determines whether the cancellation processing has been successfully performed (S1302). If no is determined in step S1302, the processing ends. If yes is determined in step S1302, the application 331 designates the client ID and secret with respect to the authorization API 304, and invokes a client ID deletion API (S1303). As in step S909 described above, the authorization API 304 authenticates the client that transmitted the request (S1304). The authorization API 304 deletes, from the client management table 610, a record whose client ID 611 matches the client ID with which the request was transmitted (S1305). The authorization API 304 returns a success (OK) to the application 331 as a response to the client ID deletion API (S1306). It is thereby possible to delete an unnecessary client ID from the application 331, and appropriately reduce the web service API usage fee from the next month.

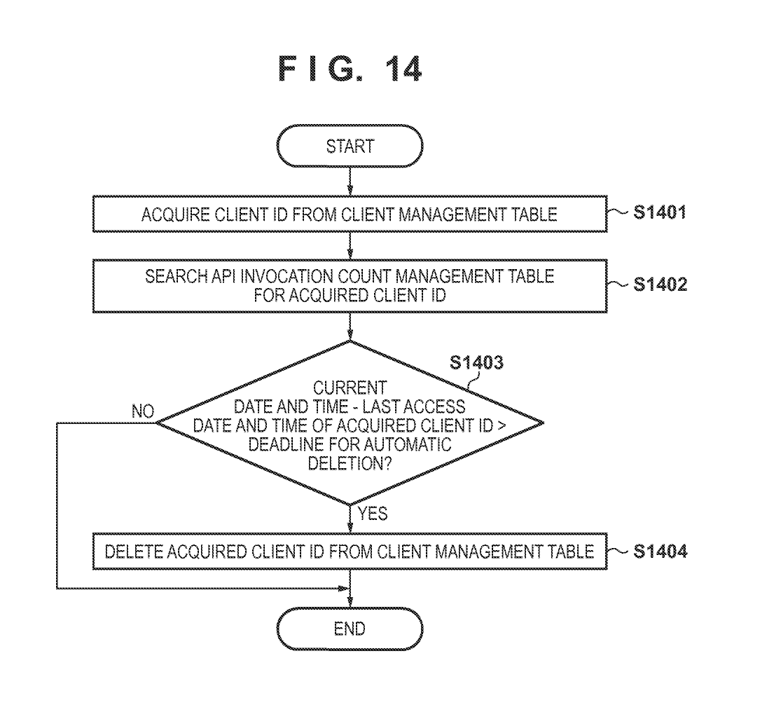

A flow of processing for automatically deleting a client ID with which there is no invocation for a predetermined length of time will be described next with reference to FIG. 14. This processing is effective in cases such as when a user abandons the use of the application without performing the procedure for deleting the client ID shown in FIG. 13, and when the application has been uninstalled. If the client ID remains registered, the web service API usage fee is continuously billed to the application developer despite the fact that there is no invocation of the web service API by using that client ID. By automatically deleting such a client ID with which there is no web service API invocation, the web service API usage fee can be appropriately reduced. As a result, the application developer does not have to pay for copies of the application 331 that are no longer used, or in other words, unnecessary cost.

Batch processing is regularly performed on the database 305 by using a program (not shown) or a stored procedure so as to automatically delete a client ID with which there is no invocation for a predetermined length of time in the following manner. The procedure shown in FIG. 14 is executed periodically (per fixed period of time). It is particularly desirable to set the unit period of the client expiration period 516 as the execution period. In this example, the client expiration period 516 is set based on days, and thus it is desirable to execute the procedure daily. First, a client ID 611 and a tenant ID 613 whose type 614 is general are acquired from the client management table 610 (S1401). The acquired client ID is searched for in the API invocation count management table 630, and the last date and time of access of the client ID written in Last Access Date and Time 635 is acquired (S1402). Then, it is determined whether the number of days obtained by subtracting the last access date and time of access of the acquired client ID from the current date and time is greater than the client expiration period 516 of the corresponding tenant ID in the tenant attribute management table 510 (S1403). If no is determined in step S1403, the processing ends. If yes is determined in step S1403, the client ID is deleted from the client management table 610 (S1404). It is thereby possible to automatically delete a client ID with which there is no access for a predetermined length of time and appropriately reduce the web service API usage fee from the next month.

As described above, the authorization server 111 provides API authorization according to the authorization flow of the OAuth 2.0 in response to an API utilization request for the API 313 of the resource server 112. In particular, it is possible to extract a client ID for each copy of the application 331 installed in the client computers 122, and manage and limit the number of API invocations to the API 313 of the resource server 112 for each client ID. It is also possible to, at the time of issuing an access token, which is processing required by the flow of authorization of the OAuth 2.0, and at the time of verifying the access token, verify whether the number of API invocations has reached the upper limit for each client ID with which the request was transmitted. Accordingly, the application developer can control the number of API invocations from distributed copies of the application 331 by using the tenant attribute management table 510 for each tenant stored in the authorization server 111, the API usage settings screen 810 and the like, and thus the problem discussed earlier in this specification is solved.

In the present embodiment, the comparison against the maximum number of API invocations is performed in two cases: when a request for the issuance of an access token is made; and when the access token is verified. It is thereby possible to suppress the issuance of an access token that cannot be used. However, if the purpose is to simply limit the number of uses, the comparison may not be performed when a request for the issuance of an access token is made.

Also, the deletion of a client ID described with reference to FIGS. 13 and 14 can be carried out independently of the issuance and verification of an access token of the present embodiment.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-001241, filed Jan. 7, 2014, which is hereby incorporated by reference herein in its entirety.

What is claimed is:

1. A rights management server comprising:
an issuing unit that, in response to an authorization request requesting delegation of an access right to a resource of a user from a registered client, verifies the authorization request and issue an access token to the client when the verification is successful; and
a verification unit that, when a resource request is received together with the access token, verifies the access token and permit access to the resource when the verification is successful,
wherein the verification unit verifies validity of the access token, also verifies whether or not the number of accesses to the resource has exceeded a maximum number of accesses set for a client that issued the resource request, and determines that the access token has been successfully verified when the access token is valid and the number of accesses to the resource does not exceed the maximum number of accesses.

2. The rights management server according to claim 1,
wherein, in addition to the verification processing by the verification unit, the issuing unit that:
when the issuing unit verifies the authorization request, verifies whether or not the number of accesses to the resource has exceeded the maximum number of accesses set for the client that issued the resource request, and
when the authorization request is valid and the number of accesses to the resource does not exceed the maximum number of accesses, issues the access token.

3. The rights management server according to claim 1,
wherein the maximum number of accesses is the maximum number of accesses per unit period.

4. The rights management server according to claim 1, further comprising a setting unit that causes a terminal to display an input screen for inputting the maximum number of accesses per client, and sets a value input on the input screen as the maximum number of accesses.

5. The rights management server according to claim 4,
wherein the input screen further includes an input field for inputting an upper limit addition value that can be added to the maximum number of accesses, and
the setting unit sets a value input on the input screen, and for a client whose number of accesses to the resource has reached the maximum number of accesses, adds the upper limit addition value to the maximum number of accesses in response to a request from the client.

6. The rights management server according to claim 5,
wherein the input screen further includes an input field for inputting addition permission information indicating whether or not to permit to raise the maximum number of accesses,
the setting unit:
sets a value input on the input screen, and
for the client whose number of accesses to the resource has reached the maximum number of accesses, when raising the maximum number of accesses is permitted by the addition permission information, adds the upper limit addition value to the maximum number of accesses in response to a request from the client.

7. The rights management server according to claim 4,
wherein the issuing unit issues an access token in response to an authorization request from the registered client,
the input screen further includes an input field for inputting a client expiration period,
the setting unit sets a value input in the input screen, and
the rights management server further includes a unit that deletes a client that has been registered but has not accessed the resource for a period exceeding the client expiration period.

8. The rights management server according to claim 1, further comprising a deletion unit that deletes the registered client in response to a request from the client.

9. The rights management server according to claim 7,
wherein the client expiration period is input from the input screen displayed on the terminal, and then set.

10. The rights management server according to claim 1,
wherein when it is verified that the access token is valid as a result of verification of the access token, access to the resource is permitted without requiring input of authentication information.

11. A resource providing system comprising:
the rights management server according to claim 1;
a terminal connected to the rights management server; and
a resource server that, when a resource request is issued from the terminal together with the access token, requests the rights management server to verify the access token, and provides a resource requested by the terminal when a response that permits the access token is received from the rights management server.

12. A non-transitory computer-readable medium storing a program for causing a computer to function as the rights management server according to claim 1.

13. A rights management method comprising the steps of:
in response to an authorization request requesting delegation of an access right to a resource of a user from a registered client, verifying the authorization request and issuing an access token to the client when the verification is successful; and
when a resource request is received together with the access token, verifying the access token and permitting access to the resource when the verification is successful,
wherein the verification step includes verifying validity of the access token, also verifying whether or not the number of accesses to the resource has exceeded a maximum number of accesses set for a client that issued the resource request, and determining that the access token has been successfully verified when the access token is valid and the number of accesses to the resource does not exceed the maximum number of accesses.
